(19) United States
(12) Patent Application Publication
(10) Pub. No.: US 2003/0163618 A1
(43) Pub. Date: Aug. 28, 2003

(54) Shared queue for multiple input-streams

(76) Inventors: Vishal Anand, Sunnyvale, CA (US); Rama Krishna Alampally, Santa Clara, CA (US)

Correspondence Address: Corporate Patent Counsel, U.S. Philips Corporation, 580 White Plains Road, Tarrytown, NY, 10591, US

(21) Appl. No.: 10/086,096

(22) Filed: Feb. 27, 2002

(51) Int. Cl. G06F 3/00

(52) U.S. Cl. 710/52

(57) ABSTRACT

A queuing system uses a common buffer for receiving input data from multiple-inputs, by allocating memory-elements in the common buffer to each input-stream, as the streams provide their input data. To allow for an independently controlled unloading of the individual data-items from the multiple-input common buffer, the system maintains a mapping of the memory locations of the buffer that is allocated to each data-item in each input-stream. To minimize the memory and overhead associated with maintaining a mapping of each data-item, memory locations that are allocated to each input-stream are maintained in a sequential, first-in, first-out queue. When a subsequent receiving device acknowledges that it is ready to receive a data-item from a particular input-stream, the identification of the allocated memory location is removed from the input-stream's queue, and the data-item that is at the allocated memory in the common buffer is provided to the receiving device.

### BACKGROUND OF THE INVENTION

1. Field of the Invention

This invention relates to the field of computer and communications systems, and in particular to a system that receives multiple input-streams that are routed to a common output port.

2. Description of Related Art

Multiple-input, common-output systems are common in the art. Multiple hosts, for example, may communicate data to a common server; multiple processors may access a common memory device; multiple data streams may be routed to a common transmission media; and so on. Generally, the input to the multiple-input system is characterized by bursts of activities from one or more input-streams. During these bursts of activities, the arrival rate of input data generally exceeds the allowable departure rate of the data to a subsequent receiving system, and buffering must be provided to prevent a loss of data.

Conventionally, one of two types of systems are employed to manage the routing of multiple input-streams to a common output, dependent upon whether the design priority is maximum memory-utilization efficiency, or maximum performance.

In a memory-efficient embodiment, a common buffer is provided for queuing the data from the input-streams, and each process that is providing an input-stream controls access to this common buffer, in accordance with a given control protocol. Data is unloaded from this common buffer to provide the common output. Because a common buffer is used to receive the flow from the various input-streams, the size of the buffer can be optimized for a given aggregate arrival rate. That is, because it is extremely unlikely that all input-streams will be active contemporaneously, the common buffer is sized substantially smaller than the size required to accommodate maximum flow from all streams simultaneously. The performance of such an embodiment, however, is dependent upon the poorest performing process that is providing an input-stream, because a poor process can tie up the common buffer while all of the other processes await access to the common buffer.

To maintain independence among processes that are providing the multiple inputs, conventional high-performance multiple-input systems typically employ multiple input buffers, as illustrated by system 100 of FIG. 1. Each buffer 110 provides a queue for receiving data from its corresponding input-stream 101. In the example of FIG. 1, a receiving system asserts an “Unload(n)” command to select the next-available data-item from the n^{th} queue, and this selected data-item Qₙ is subsequently communicated to the receiving system. The selection of the particular input data stream, n, is typically effected based on a prioritization scheme. Not illustrated, the system 100 typically includes a means for notifying the receiving system that data from an input-stream is available, and the receiving system selects from among the available streams based on a priority that is associated with the stream. Alternative protocols for controlling the flow of data from a plurality of input-streams are commonly employed, including, for example, transmission control in the system 100 and a combination of transmission and reception control by the system 100 and the receiving system, respectively. In like manner, the selection of the particular input-stream may include any of a variety of schemes, including a first-in-first-out selection, a round-robbin selection, and so on, in addition to, or in lieu of, the aforementioned priority scheme.

The design choices for a multiple-input system include a choice of the size, D, of the input queues. Based on the estimated input and output flow rates, a queue size D can be determined to minimize the likelihood of an overflow of the queue. For ease of understanding, the queues associated with each input-stream 101 of system 100 are illustrated as being similarly sized. If it known that a particular input-stream has a flow rate that substantially differs from the other input-streams, it may be allocated a smaller or larger queue size. As illustrated, the system 100 is configured to allow a maximum burst of D data-items from any of the input-streams, based on the expected processing speed of the subsequent receiving system. Queuing theory techniques are common in the art for determining an optimal value of D, given an expected distribution of arrivals of data-items at any input-stream and an expected distribution of removals of the data-items by the subsequent receiving system.

Because the queue size D is based on estimated arrival rates of data-items from each input-stream, each queue is sized to accommodate a worst-case estimate of arrivals. Although a particular input-stream may frequently come near to filling its queue, the likelihood of all of the input-streams simultaneously coming near to filling all of their queues is generally extremely low. Viewed another way, the number of unused memory locations among all of the queues at any given time is generally extremely high, and thus the memory-utilization efficiency of the conventional multiple-queue multiple-input system 100 is extremely low.

### BRIEF SUMMARY OF THE INVENTION

It is an object of this invention to provide a multiple-input device and method that maximizes memory-utilization efficiency. It is a further object of this invention to provide a multiple-input device and method that maximizes memory-utilization efficiency while maintaining a high performance. It is a further object of this invention to provide a high-performance multiple-input device that minimizes the area consumed by memory devices.

These objects, and others, are achieved by providing a multiple-input queuing system that uses a common buffer for receiving input data from the multiple-inputs, and a local arbitration unit that allocates memory-elements in the common buffer to input-streams, as the streams provide their input data. To allow for an independently controlled unloading of the individual data-items from the multiple-input common buffer, the system maintains a mapping of the memory locations of the buffer that is allocated to each data-item in each input-stream. To minimize the memory and overhead associated with maintaining a mapping of each data-item, memory locations that are allocated to each input-stream are maintained in a sequential, first-in, first-out queue. When a subsequent receiving device acknowledges that it is ready to receive a data-item from a particular input-stream, the identification of the allocated memory location is removed from the input-stream's queue, and the data-item that is at the allocated memory in the common buffer is provided to the receiving device.

### BRIEF DESCRIPTION OF THE DRAWINGS

The invention is explained in further detail, and by way of example, with reference to the accompanying drawings wherein:

FIG. 1 illustrates an example block diagram of a prior art multiple-input queuing system.

FIG. 2 illustrates an example block diagram of a multiple-input queuing system in accordance with this invention.

FIG. 3 illustrates an example block diagram of a multiple-input queuing system with a multiple-queue memory-allocation map in accordance with this invention.

Throughout the drawings, the same reference numerals indicate similar or corresponding features or functions.

### DETAILED DESCRIPTION OF THE INVENTION

FIG. 2 illustrates an example block diagram of a multiple-input queuing system 200 in accordance with this invention. The system 200 includes a dual-port memory 220, wherein writes to the memory 220 are controlled by an allocator/arbitrator 240 (hereinafter allocator 240), and reads from the memory 220 are controlled by a mapper/sequencer 250 (hereinafter mapper 250). The write and read processes to and from the memory 220 are symbolically represented by switch 210 and switch 260, respectively.

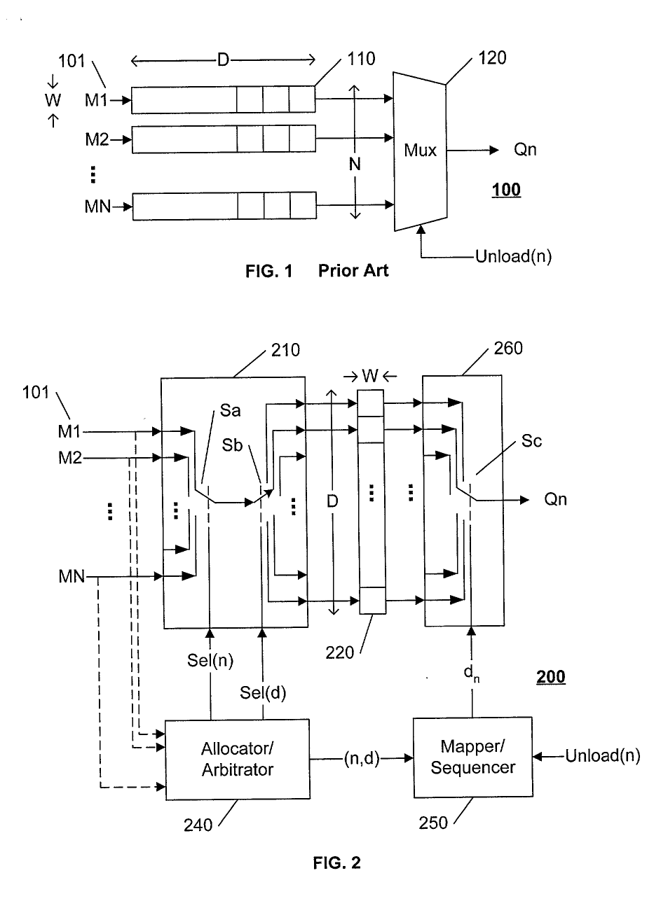

As illustrated in FIG. 2, the memory 220 includes P addressable memory-elements, and each memory-element is of sufficient width W to contain a data-item from any of the input-streams 101. Using conventional queuing theory techniques, the number P of memory-elements required to provide a given level of confidence in avoiding an overflow of the memory 220 can be determined, based on the expected input and output flow rates, as discussed above with regard to the prior art system 100 of FIG. 1. Preferably, the parameter P in system 200 is at least as large as parameter D in system 100. Note, however, that the system 100 includes a total of N*D memory-elements of width W, whereas the memory 220 includes a total of P memory-elements of width W.

The allocator 240 is configured to provide the location of a currently-unused memory-element within the memory 220, to which the next data-item from the input-streams 101 is directed, as indicated by output switch Sb in the switch 210. As indicated by the dashed lines between the input-streams 101 and the allocator 240, the allocator 240 is configured to receive a notification whenever an input-stream 101 has a new data-item to be transmitted. In a preferred embodiment, the allocator 240 includes arbitration logic, in the event that two or more input-streams 101 have data to transmit contemporaneously. In a straightforward embodiment, for example, the input ports to the switch 210 may be assigned a sequentially ordered priority, the first port being of highest priority, the second port being of lesser priority, and so on. Each input-stream M1, M2, . . . MN is physically connected to the particular port depending upon its priority. In such an example, the allocator 240 merely selects, via the input switch Sa, the lowest numbered port that has a data-item to be transmitted. Other priority schemes are common in the art, including dynamic prioritization based on the content of each data-item, or based on a prior history of transmissions from one or more of the input-streams 201, and others. Alternatively, a simple round-robin input selection scheme may be used, wherein the allocator 240 sequentially samples each input-stream 201 for new data, and routes the new data to the next-available unused memory-element in memory 220 in the order in which it is sampled. One of ordinary skill in the art will recognize that the particular scheme used to resolve potential conflicts among the variety of input-streams is independent of the principles of this invention.

Of note, and discussed further below, the allocator 240 is configured to note the removal of data-items from the individual memory-elements. As each data-item is removed, the memory-element that had contained this data-item is now available for receiving new data-items, as a currently-unused memory-element. An overflow of the memory 220 only occurs if all P memory-elements are filled with data-items that have not yet been removed.

Because any input-stream has access to any currently-unused memory-element in the memory 220, the system 100 exhibits the memory-utilization efficiency of the common-buffer system discussed in the Background of The Invention. However, because the allocator 240 is configured to allocate each available memory-element as required, the system 200 is not dependent upon a control of the memory 220 by one or more of the processes that are providing the input-streams.

Further, because the allocation and arbitration functions of the allocator 240, and in particular the allocator's interactions with the switch 210 are substantially independent of the processes that provide the input-streams 101, modifications to the allocator 240 and switch 210 can be effected without requiring changes to the processes that provide the input-streams 101. For example, to improve performance and reduce the likelihood of conflicts among the input-streams 101, the switch 210 may be configured to allow for the simultaneous routing of multiple data-items to multiple memory-elements in the memory 220. That is, switch Sa is illustrated in FIG. 2 as an N-to-1 switch and switch Sb as a 1-to-P switch. Alternatively, to support up to k simultaneous transfers, switches Sa and Sb may be N-to-k and k-to P switches, respectively. Such a change, however, will be ‘transparent’ to the input-streams M1 . . . MN, in that the processes that provide the data-items need not be modified to be compatible with an N-to-1 switch, as compared to an N-to-k switch.

The mapper 250 is configured to assure that data-items are unloaded/removed from the memory 220 in an appropriate order. If the sequence of output data-items Qn is intended to correspond to the same sequence that the data-items are received, the mapper 250 need merely operate using the same sequence that is applied to control switch Sb in switch 210. That is, for example, if the switch Sb operates to sequentially select memory-elements in memory 220, the mapper 260 would also be configured to sequentially select the memory-elements in memory 220 for communication to a subsequent receiving system. Typically, however, the system 200 is configured to allow the subsequent receiving system to receive data-items in a somewhat independent manner.

In a typical embodiment, as discussed above in the Background of the Invention, the receiving system calls for data-items in a sequence that may differ from the sequence in which the data-items are received at the multiple-input queuing system 200. In a preferred embodiment, the system 200 is configured to allow the receiving system to specify the input-stream, n, from which the next data-item is to be sent. In this manner, for example, a process at an input-stream n may initiate a request to send m data-items to the receiving system, and the receiving system subsequently sends m “unload(n)” commands to the queuing system 200 to receive these m data-items, independent of the arrival of other data-items at system 200 from the other input-streams 101. That is, relative to each input-stream, the data-items are provided to receiving system in sequence, but the receiving system may call for the data-items from select input-streams independent of the order of arrival of data-items from other input-streams.

To allow the receiving system to request a sequence of data-items from a select input-stream, the allocator 240 communicates the allocation of each memory-element location, p, to each input-stream, n, as a stream-element pair (n,p), to the mapper 250. The mapper 250 thereby maintains a list of each memory-element location indicator, pₙ, that is sequentially assigned to each arriving data-item from each input-stream, n. When the receiving system requests the “next” data-item from a particular input-stream, n, the mapper 250 extracts the next location indicator, pₙ, from the list associated with the input-stream n, and uses that location indicator pₙ to provide the contents of the memory-element p as the output Qn, via the switch 260. This location indicator pₙ is removed from the list associated with the input-stream n, and the allocator 240 thereafter includes the memory-element p as a currently-unused memory location.

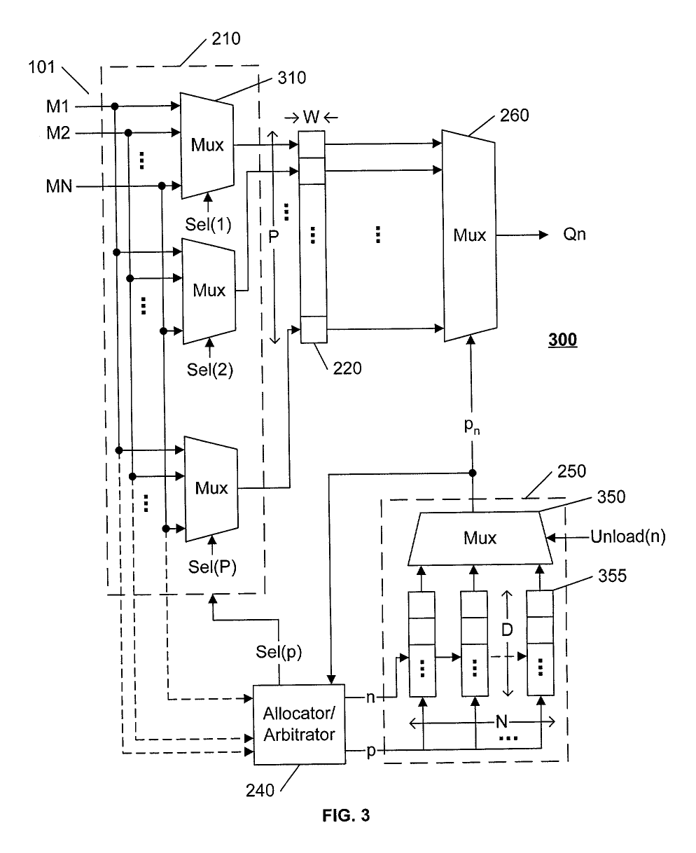

FIG. 3 illustrates an example block diagram of a multiple-input queuing system 300 with a multiple-queue memory-allocation map in accordance with this invention, as would be suitable for use as a mapper 250 in the system 200 of FIG. 2. Other embodiments of a mapper 250 will be evident to one of ordinary skill in the art in view of this disclosure.

In the example embodiment of FIG. 3, the mapper 250 includes multiple first-in-first-out (FIFO) queues 355, each queue 355 being associated with a corresponding input-stream 101 to the multiple-input queuing system 300. When the allocator 240 allocates a memory-element p to an input-stream n, the address of this memory-element, p, is stored in the queue corresponding to input-stream n, the index n being used to select the queue 355 corresponding to input-stream n. As each new data-item is received from an input-stream, the address, p, at which the data-item is stored, is stored in the queue corresponding to the input-stream, in sequential order.

Each queue 355 in the example mapper 250 of FIG. 3 is illustrated as having a queue-length of D, consistent with the prior art queue lengths illustrated in FIG. 1. Note, however, that the width of the queues 110 of FIG. 1 is W, so that the total size of each queue 110 is D*W. Because each queue 355 of FIG. 3 is configured to store an address to the P memory-elements, the total size of each queue 355 is D*log₂P. In a typical embodiment, the width of the address, log₂P is generally substantially less than the width of a data-item. For example, if the data-items are 32-bits wide, and the buffer 220 is configured to hold 1024 data-items (log₂(1024)=10), the queues 355 of FIG. 3 will be less than a third (10/32) of the size of the buffers 110 of FIG. 1.

When the receiving system requests the next data-item from a select input-stream, via an “Unload(n)” command, a multiplexer/selector 350 selects the queue corresponding to the select input-stream, n, and the next available index, pₙ, is removed from the select queue 355. The index pₙ is used to select the corresponding memory-element p, via that switch/multiplexer 260, to provide the output Qn corresponding to the Unload(n) request from the receiving system. After the data-item in the memory-element p is selected for output, the allocator 240 includes the memory-element p as a currently-unused memory-element, thereby allowing it to be allocated to newly arriving data-items, as required.

Also illustrated in FIG. 3 is an example embodiment of a multiple-input, multiple-output, switch 210 that is configured to route a data-item from an input-stream 101 to a selected memory-element, p, in a memory 220. The example switch 210 includes a multiplexer/selector 310 corresponding to each memory-element of the memory 220, that is enabled via a select(nₚ) command from the allocator 240. In this example embodiment, each multiplexer/selector 310 associated with each memory-element is configured to receive a select(nₚ) command, wherein nₚ identifies the select input-stream that has been allocated to the memory-element. In this manner, the data-item from the n^{th} input-stream is routed to the p^{th} memory-element. Note that this example embodiment allows for the storage of data-items from multiple contemporaneous input-streams. That is, for example, if input-streams 1, 3, and 7 are currently attempting to transmit data-items, and memory-elements 2, 8, and 13 (and, perhaps others) are currently-unused, the allocator 240 in a preferred embodiment will assert select(1), select(3), and select(7) commands to the multiplexers 310 that are associated with memory-elements 2, 8, and 13, respectively, thereby simultaneously routing input-stream 1 to memory-element 2, input-stream 3 to memory-element 8, and input-stream 7 to memory-element 13.

Alternative methods for routing data-items from multiple input-streams to allocated memory locations will be evident to one of ordinary skill in the art in view of this disclosure. For example, FIG. 3 illustrates an N-to-1 multiplexer 310 associated with each memory-element of the buffer 220, to select from among N input-streams; in an alternative embodiment, a 1-to-P selector may be associated with each input-stream 101, to route each input-stream to a selected memory-element of the buffer 220.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

We claim:

1. A multiple-input queuing system comprising:
a buffer that includes a plurality of memory-elements,
an allocator that is configured to allocate a memory-element of the plurality of memory-elements for storing a data-item from a select input-stream of a plurality of input-streams, and
a mapper that is configured to:
receive a request) for an output corresponding to the select input-stream,
determine an address associated with the memory-element, based on the request for the select input-stream, and
provide the data-item from the memory-element as the output, based on the address associated with the memory-element.

2. The multiple-input queuing system of claim 1, further including
a first switch, operably coupled to the allocator, that is configured to route the data-item from the select input-stream to the memory-element.

3. The multiple-input queuing system of claim 2, further including
a second switch, operably coupled to the mapper, that is configured to route the data-item from the memory-element to the output.

4. The multiple-input queuing system of claim 1, wherein
the allocator is further configured to allocate the memory-element based on a request from the select input-stream for an allocation.

5. The multiple-input queuing system of claim 4, wherein
the allocator is further configured to:
receive allocation requests from other input-streams of the plurality of input-streams,
determine a relative priority of the allocation requests from the other input-streams and the request from the select input-stream, and
identify the select input-stream, based on the relative priority.

6. The multiple-input queuing system of claim 4, wherein
the allocator is further configured to:
receive allocation requests from other input-streams of the plurality of input-streams, and
allocate other memory-elements of the plurality of memory-elements for storing other data-items from the other input-streams.

7. The multiple-input queuing system of claim 6, wherein
the allocator is configured to allocate the other memory-elements contemporaneously with allocating the memory-element for storing the data-item from the select input-stream.

8. The multiple-input queuing system of claim 6, wherein
the mapper that is further configured to:
receive requests for outputs corresponding to the other input-streams,
determine addresses associated with the other memory-elements, based on the request for the other input-streams, and
provide the other data-items from the other memory-element as outputs from the multiple-input queuing system, based on the addresses associated with the other memory-element.

9. A buffer system that is configured to receive data from a plurality of input-streams, the buffer system comprising:
a plurality of memory-elements,
a plurality of input-multiplexers, each input-multiplexer being coupled to a memory-element of the plurality of memory-elements, and
an allocator, operably coupled to the plurality of memory-elements, that is configured to couple one or more input-streams of the plurality of input-streams to corresponding one or more memory-elements, via allocation commands to the plurality of input-multiplexers.

10. The buffer system of claim 9, further including:
a mapper, operably coupled to the allocator, that includes:
a memory that is configured to store information corresponding to the allocation commands, and
a multiplexer, operably coupled to the memory, that is configured to access the information corresponding to the allocation commands, and to thereby provide an identification of the one or more memory-elements corresponding to a select input-stream of the plurality of input-streams, and
an output-multiplexer, operably coupled to the plurality of memory-elements and to the mapper, that is configured to couple a select memory-element of the plurality of memory-elements to an output of the buffer system, based on the identification of the one or more memory-elements corresponding to the select input-stream.

11. The buffer system of claim 10, wherein
the memory of the mapper includes
a plurality of queues, each queue of the plurality of queues corresponding to each input-stream of the plurality of input-streams.

12. A method of buffering data-items from a plurality of input-streams, including:
receiving an input-notification from one or more input-streams of the plurality of input-streams,
allocating a select memory-element of a plurality of memory-elements to a select input-stream of the one or more input-streams,
storing a received data-item from the select input-stream to the select memory-element,
storing an identification of the select memory-element corresponding to the select input-stream,
receiving an unload request) that identifies the select input-stream, and
providing the received data-item from the select memory-element, based on an identification of the select memory-element corresponding to the select input-stream.

13. The method of claim 12, further including
allocating a plurality of select memory-elements of the plurality of memory-elements to a plurality of select input-streams of the one or more input-streams,
storing a received data-item from each of the plurality of select input-streams to a corresponding each of the plurality of select memory-elements, and
storing an identification of each of the plurality of select memory-elements corresponding to each of the plurality of select input-streams.

14. The method of claim 12, wherein:
storing the identification of the select memory-element includes
placing the identification in a first-in-first-out queue that is associated with the select input-stream, and
providing the received data-item includes
removing the identification from the first-in-first-out queue that is associated with the select input-stream.

15. The method of claim 12, wherein:
each memory-element of the plurality of memory-elements is dynamically classifiable as currently-used and currently-unused;
allocating the select memory-element includes:
identifying one of the plurality of memory-elements that is classified as currently-unused as the select memory-element, and
classifying the select memory-element as currently-used; and
providing the received data-item includes
classifying the select memory-element as currently-unused.
